(19) United States
(12) Patent Application Publication
(10) Pub. No.: US 2006/0264136 A1
(43) Pub. Date: Nov. 23, 2006

(54) Fabric with high fire-resistant properties

(76) Inventor: Gennaro Chiantese, Napoli (IT)

Correspondence Address: HEDMAN & COSTIGAN P.C., 1185 AVENUE OF THE AMERICAS, NEW YORK, NY, 10036, US

(21) Appl. No.: 10/547,139

(22) PCT Filed: Feb. 25, 2004
(86) PCT No.: PCT/IB04/01239

§ 371 Date: Jun. 26, 2006

(30) Foreign Application Priority Data
Feb. 25, 2003 (IT) V12003A000037

(51) Int. Cl. D04B 21/00; B32B 27/12; B32B 27/04

(52) U.S. Cl. 442/304; 442/136; 428/920; 428/921

(57) ABSTRACT

A fabric with high fire-resistant properties, consisting of various types of yarns consisting of meta-aramidic or para-aramidic fibers and fibers based on pre-oxidized carbon or novoloid, respectively, which are highly fire-resistant materials; the fabric can be of the multilayer type and can also include the use of cotton, wool or viscose fibers, having high comfort properties and good wearability, and/or textile fibers with conductivity characteristics, in order to obtain further shielding properties of the non-ionizing waves generated by electromagnetic fields and/or antistatic and dissipative properties, in general.

The present invention relates to a fabric having high fire-resistant properties.

Fire-resistant fabrics and fire-fighting devices which can be used on said fabrics have been generally known for a long time.

The fire-resistant and antistatic properties of the known fabrics however still have a low efficacy and limited efficiency particularly when flames and/or static electricity charges, at times together with the presence of corrosive chemical products, generate high temperatures, which cause the perforation of the fabric in short times.

Furthermore, when traditional products are attacked by flames and heat, they release large amounts of toxic fumes during the whole combustion period, with very harmful consequences for the user.

Finally, in the fabrics used so far, the fire-resistant and antistatic properties are decidedly incompatible with the high comfort and good wearability, with consequent difficulties of the fabric in the general field of fire-fighting security as a whole.

An objective of this invention is therefore to overcome the above-mentioned drawbacks and, in particular, to provide a fabric having high fire-resistant properties, highly resistant to heat and, at the same time, having remarkable elasticity and yielding characteristics for an adequate wearability, as well as high mechanical resistance.

Another objective of the present invention is to manufacture a fabric having high fire-resistant properties, highly resistant to the attack of chemical products and, in particular, acids.

A further objective of the present invention is to provide a fabric having high fire-resistant properties, which is also repellent with respect to all chemical liquids and stain-resistant.

Yet another objective of the invention is to provide a fabric with high fire-resistant properties, also having shielding properties of the non-ionizing waves generated by electromagnetic fields and/or radio frequency.

The last but not least important objective of the invention is to provide a fabric with high fire-resistant properties, which also has antistatic and dissipative properties so as to form a protective element from fire and heat and, at the same time, a means of protection from chemical and antistatic substances, for the dissipation of electrostatic and tribo-electric charges.

These and other objectives are achieved within the scope of the present invention, by producing a fabric having high fire-resistant properties, according to claim 1, to which reference is made for the sake of brevity.

The multilayer fabric of the present invention, also advantageously has excellent fire-resistant and antistatic properties, together with a high comfort and good wearability.

The specific fire-resistant properties of this fabric represent an absolute novelty, in the field of fire-fighting devices, due to its efficacy and efficiency, and make this invention a revolutionary product, which can be widely used in the field of fire-fighting safety.

Unlike other fire-resistant fabrics at present on the market (defined as “FR” for Flame-Retardant), the fabric, object of the present description, in addition to not spreading flames, does not burn or carbonize; it therefore has the essential characteristic of remaining soft until total sublimation, as deterioration takes place over a much longer period of time with respect to other fire-resistant fabrics currently commercialised.

Furthermore, the fabric in question has a very low emission of fumes, and even the absence of poisoning or harmful fumes, in the case of combustion, and has a high tear-resistance and tensile strength (and therefore very slow wear with time).

Finally, the fabric is transpiring, light, and has a pleasant feel and, when suitably treated, in addition to the above-mentioned characteristics, it can also be repellent to all chemical liquids and is stain-resistant, so that it can be preserved from the damage of chemical substances such as grease, oils, acids, chlorine, etc.

No type of washing or the duration or number of washings can eliminate or limit the above-mentioned characteristics of the fabric.

Finally, further particular types of treatment give the fabric antistatic and dissipative characteristics of electrostatic and tribo-electric charges, together with bacterio-static properties, anti-microbial and anti-bacterial properties, as well as shielding properties (of the non-ionizing waves generated by electromagnetic fields or radio frequencies).

Further characteristics and advantages of a fabric having high fire-resistant properties, according to the present invention, will appear even more evident from the following description, which relates to an illustrative but non-limiting embodiment of the fabric in question.

It should be noted that the basic idea of the invention relates to the fire-proofing protection applied to a product of general use, such as the fabric; the invention therefore relates to any hypothetical use of a fire-resistant fabric, regardless of the type of embodiment and/or use of the same, for purely illustrative and non-exhaustive purposes of the possible cases, regardless of the product created with said fabric, the type of user of said fabric and the purpose for its use.

The fabric can be used, for example, for producing clothes for all categories of workers who require protection from fire and/or heat and/or chemical substances, such as firemen, civil protection workers, forest rangers, foundry workers, welders, workers in the chemical and petrochemical industry, hospitals, power stations, military navy, air and land forces, etc.

The above-mentioned fabric can also be used for making tents, camp beds, seat covers, etc.

The fabric is produced for the desired purposes, using two different types of yarns, consisting of meta-aramidic or para-aramidic fibers or novoloid, or pre-oxidised carbon fibers, respectively; the latter can have polyacrylonitrile (PAN) or novoloid, as precursor.

A yarn made of cotton, wool or viscose fibers can be coupled with the above yarns, in order to obtain an adequate comfort and good wearability for the user, and to have the possibility of choosing the desired colours.

In particular, according to a first illustrative but non-limiting embodiment of the present invention, at least one pre-oxidised carbon fiber is used having polyacrylonitrile as precursor, which is soft and highly resistant to heat and is therefore fire-resistant.

The above-mentioned pre-oxidised carbon fibers are coupled with at least one para-aramidic fiber (para-phenylene-terephthalamide), which, in addition to being particularly heat- and fire-resistant, also has a considerable mechanical resistance.

In particular, the pre-oxidised carbon fiber (oxidised polyacrylonitrile), has an extremely high heat-resistance (“FB” or “Fire-blocking” material), a corrosion resistance to acid or basic chemical agents, within the pH range of 2 to 14, a linear electrical resistance equal to 10¹¹ Ω/cm, antistatic properties, with the total dissipation of static electricity and a minimum dimension of the particle size equal to 6.5 μm.

Due to its fire-resistant properties, this pre-oxidised carbon fiber does not have an ignition point or melting point and can resist at high temperatures, subsequently losing its relative umidity and reducing itself by sublimating (i.e. passing directly from the solid state to the gaseous state, without intermediate steps).

The pre-oxidised carbon fiber is also totally free of all carcinogenic substances (under all conditions of use) and does not carbonize (if woven, it keeps its elasticity until total sublimation).

The para-aramidic fiber used (para-phenylene-terephthalamide) has an impact strength of 67 N, an ultimate tensile stress of 135 CN/TEX and fire-resistant properties (it does not spread flames), a high tensile strength and impact resistance, a high dielectric capacity (it does not transmit electric charges).

The fabric according to the invention can be a multilayer composite fabric of the knitted or shuttle material type.

In order to obtain a multilayer, for example, a four-layered fabric, a natural textile fiber can be used on the external side of the first fabric, bound with the “vanisé” technique, for example, to the pre-oxidised carbon fiber, with the natural fiber on the external side, and the pre-oxidised carbon fiber on the internal side; a second fabric can be placed on the side in contact with the pre-oxidised carbon fiber and bound to the latter by means of tacking of a few orders, according to the “Facon Metier” method, made up of a para-aramidic fiber, bound to a natural fiber by means of, for example, the same “vanisé” technique, so that the para-aramidic fiber is in contact with the pre-oxidised carbon fiber, whereas the natural fiber remains on the inner side, opposite to that of the natural fiber of the first fabric.

The application of para-aramidic fibers, synergically with other textile fibers, or alone, generates a multilayer composite knitted fabric, which has further particular characteristics suitable for improving the performances of fabrics of the same type currently present on the market.

The “vanisé” technique, for example, used by applying the natural fiber (such as cotton) to the outside, but firmly bound to the pre-oxidised carbon fiber of the fabric, allows said fabric to behave as a fire-retardant, preventing the propagation of flames.

In the case of a double-face fabric, such as that described above, i.e. consisting of a first fabric with two fibers (of which one of carbon and the other natural, joined by means of the vanisé method), which is joined, by means of tacking, with the Fa con Metier technique, to a second fabric similar to the first or consisting of a yarn including a natural fiber joint in vanisé to a pre-oxidised carbon fiber or a para-aramidic fiber, an air cushion is formed between these two fabrics, due to the specific “double face” configuration, which allows the thermal insulation to be increased and prevents heat transmission from the external to the internal of the multilayer composite fabric.

The fabric thus produced and joined to natural fibers, is hygienic and comfortable when used for clothing, much more so than those of other fabrics of the same kind currently on the market.

The fabric in question can also be used in all fields where textile fibers are necessary, both for every-day use and special use and, in particular, in technical fields, sport, in the chemical industry, for furnishing (for example, pillowcases, mattress lining, the production of blankets and overalls) or for various uses, such as those relating to fire extinguishing interventions.

The fabric thus produced can also be used for military clothing, when antistatic and fireproof characteristics are required, as well as in industrial applications in general, where this kind of fabric can preserve users from flames and/or charges or static electricity or corrosive chemical products which are harmful for those operating in these environments; the fabric can also be used for lining all kinds of electric cables.

Combinations of fibers forming the fabric can obviously vary, as already described, as it is possible to obtain, for example, an external fabric made up of two fibers (such as a natural fiber and a pre-oxidised carbon fiber woven in “vanisé”) joined by means of tacking to a second fabric consisting of a natural fiber only or, as an alternative, of a pre-oxidised carbon fiber or a para-aramidic fiber, so as to obtain a multilayer three-layered fabric.

In the same way, it is possible to have only one double-face fabric, using a two-layer fabric, one of which is a pre-oxidised carbon fiber and a second layer made of a para-aramidic fiber and in which these two fibers are obtained, in order to have a greater compactness, by means of the “vanisé” method; two fabrics can also be obtained, one made of pre-oxidised carbon fiber and the other of para-aramidic fiber, joined by tacking according to the “Facon Metier” method.

These fabrics also have considerable fire-resistant properties, antistatic characteristics and resistance to corrosive substances, together with a good mechanical resistance (thanks to the use of the para-aramidic fiber).

In this respect, tests carried out on a particular solution of fabric (in particular a fabric produced with outer cotton in “vanisé” and a pre-oxidized carbon fiber, double-face bound with a further cotton fabric) demonstrated that, when in direct contact with a flame produced with a GPL burner, at a temperature of about 500° C., the fabric is perforated only after about 20 minutes of continuous exposure, and the fabric only releases fumes in the first two minutes.

It is also evident that this multilayer composite fabric can be produced, for the sake of practicalness, using knitting looms, but it can also be obtained with looms for weft or heddle fabrics.

As an alternative to the meta-aramidic fiber, it is possible to use at least one para-aramidic fiber (phenylene-terephthalamide), and this para-aramidic yarn can alternatively consist of 100% para-aramidic fiber or mixing a pre-oxidized carbon fiber with the para-aramidic fiber, up to a maximum of 30% of the former.

In the same way, the pre-oxidized carbon fiber (which has polyacrylonitrile as precursor) can alternatively consist of 100% of pre-oxidized carbon fiber or mixing the para-aramidic fiber with the pre-oxidized carbon fiber up to a maximum of 60% of the former.

The ideal compositions of the two yarns, however, comprise a first yarn made for 100% of para-aramidic fiber and a second yarn consisting of a mixture of 70% of pre-oxidized carbon fibers and 30% of para-aramidic fibers.

Also in this case, in addition to the specific characteristics of pre-oxidized carbon fibers (very high performance fireproof properties, antistatic, thermo equi-potentiality, anallergic, anti-microbial and anti-bacterial properties, high resistance to chemical substances, with a pH range of 2 to 14), which do not burn or carbonize, but remain soft until total sublimation, when attacked by flames, there are also particular characteristics of para-aramidic fibers, such as fireproof properties, a high impact strength, tear resistance and tensile strength and the possibility of “paste” dyeing.

For the production of this type of fabric, it is possible to use any type of weave which allows a combination of the two yarns; in this respect, the best weaves which allow an optimum use of this type of fabric are the following:

with a warp and weft (alternatively, with the para-aramidic yarn in weft and the pre-oxidized carbon fiber in warp, or vice versa), in the “Satin” technology, in all the possible backings off, from 5 upwards, in the “Twill” technology (“Peg” or “Diagonal”), in all the possible backings off, from 3 upwards, or in the “Brittle peg” technology (“Turkish Satin”), from 4 upwards;

with two warps and two or three wefts in all combination variations of the para-aramidic and pre-oxidized carbon yarns, in the “double face” technology, obtained with any technique used in weaving.

The basis weights of the fabric in question, expressed in g/m², are not binding, as a variation thereof, with the basic characteristics remaining unchanged, is due to the specific demands of the single fields of application and the specific conditions of use of the fabric; finally, the fabric can be produced with the weight which is considered adequate with respect to the specific use for which it is destined.

It is also possible to use a novoloid fiber, to be coupled with the para-aramidic fiber. In this case, the para-aramidic yarn can alternatively consist of 100% of para-aramidic fiber or mixing the novoloid fiber with the para-aramidic fiber (during the spinning, by means of the known mixing, coupling, twisting methods, the Core Span technique, etc., or combining the weaving threads), up to a maximum of 30% of the former.

The novoloid can, on the other hand, alternatively consist of 100% of novoloid fiber or mixing the para-aramidic fiber with the novoloid fiber (during the spinning, by means of all possible methods, such as mixing, coupling, twisting, the Core Span technique, etc., or combining the weaving threads), up to a maximum of 60% of the former.

The specific characteristics of novoloid fibers (which is an inert material) allow the fabric not to burn or carbonize when attacked by flames, but to remain soft until total sublimation; furthermore, they have a high resistance to chemical substances and a low emission of fumes (and absence of toxic fumes) in the case of combustion.

The specific characteristics of para-aramidic fibers, in turn, allow a high impact strength to be obtained, together with a high tear resistance and tensile strength, with very high fireproof performances (if attacked by flames, they burn but do not allow the flame to spread) and allow “paste” dyeing to be effected.

The fabric thus produced has a very slow wear, it is transpiring, light, has a pleasant feel and, in addition, when suitably treated, can also have repellent properties with respect to all chemical liquids and is stain-proof; these two latter characteristics allow the fabric to have the protection certification against acids and the above treatment confers the above properties in addition to all the others, which are thus preserved.

Finally, neither the type nor the number or duration of washings can eliminate or limit the fire-resistance properties or those of high resistance to chemical substances and a considerable mechanical resistance.

The types of weaves that can be used are all those which allow the combination of para-aramidic and novoloid yarn; in any case, the best weaves which allow an optimum use of the fabric thus formed are those described above, referring to the combination of phenylene-terephthalamide (para-aramidic yarn) and oxidized polyacrylonitrile (pre-oxidized carbon fiber).

Another property which can be conferred to the above fabric, in addition to the others already mentioned, is the rib-stop property; in this case, it is necessary to insert, both in weft and warp, a yarn of the same kind but with a greater thickness, thus obtaining a visible relief on the fabric which has the appearance of a “network”, in which the dimension of the squares of the “network” is from 1 to 5 mm, depending on the resistance value of the rib-stop to be obtained.

Also in this case, the basis weights of the fabric, expressed in g/m², are not binding, as their variation is due to the specific demands and conditions of use of the fabric.

The fabric in question, in addition to its non-flame-spreading property, does not burn or carbonize, remaining soft until total sublimation; thanks also to the high overall mechanical resistance, deterioration is thus verified over a much longer period of time with respect to the traditional fireproof fabrics.

Textile fibers with characteristics of conductivity, can also be added to the above fibers (para-aramidic fibers and novoloid fibers), such as stainless steel filaments (of the 316L type), polyamide (PA) fibers with a carbonized surface, polyamide (PA) fibers with a copper sulfide surface, polyester (PES) fibers with a copper sulfide surface, pre-oxidized carbon fibers having polyacrylonitrile (PAN) as precursor, antistatic filaments based on activated carbon and, however, any other kind of textile fiber having conductivity properties.

The yarn consisting of conductive textile fibers can be used alone or coupled with para-aramidic and/or novoloid yarns, in any combination, either with spinning methods (mixture, coupling, twisting, Core Span technique, etc.) or combining the threads in weaving.

In particular, the para-aramidic yarn can, also in this case, alternatively consist of 100% of para-aramidic fiber or mixing the novoloid fiber with the para-aramidic fiber, during spinning or coupling the threads in weaving, up to a maximum of 30% of the former, whereas the novoloid yarn can alternatively consist of 100% of novoloid fiber or mixing the para-aramidic fiber during spinning or coupling the threads in weaving, with the novoloid fiber up to a maximum of 60% of the former.

The types of weaves which can be used are those adopted and described above for the other forms of fire-resistant fabric according to the invention.

Particular mention should be made for the optimal insertion of textile fibers with conductivity properties.

This yarn must in fact have a percentage weight, in relation to the basis weight of the fabric, varying from 1% to 3% (if steel filaments are used) and up to 5% (using the other conductive fibers mentioned).

Furthermore, the conductive yarn must form a “network” in the fabric (invisible to the eye), whose base square has a side with a dimension equal to 3-7 mm, depending on the antistaticity value to be obtained from the fabric, with respect to the specific use for which it is destined.

The above values can vary from 10⁵ Ω/cm² to 10⁸ Ω/cm² for an antistatic and dissipative fabric, or from 10⁹ Ω/cm² to 10¹¹ Ω/cm² for an antistatic fabric.

In order to obtain shielding properties of the non-ionizing waves generated by electromagnetic fields or radio frequency (microwaves, ultra-red rays, etc.), the conductive textile fibers must have a percentage weight, in relation to the basis weight of the fabric, varying from 10% to 15%, if steel filaments are used, and up to 20% using any of the other conductive fibers mentioned above.

The conductive yarn must therefore form a “network” in the fabric, not visible to the eye, with the base square whose side has a dimension equal to 1-3 mm, depending on the conductivity value to be obtained from the fabric, with respect to the specific use for which it is destined; the above values can vary from 0 Ω/cm² to 10⁵ Ω/cm².

The “network” is obtained by suitably spacing out, both in weft and warp, the conductive yarn (either pure or mixed with para-aramidic and/or novoloid fibers) and the above insertion in no way influences the traditional formation of the fabric (as the “network” is not visible to the eye).

In order to provide the fabric with further rib-stop properties, a yarn of the same kind but with a greater thickness, is inserted, both in weft and warp, thus obtaining a visible relief on the fabric, also having the appearance of a “network” and in which the dimension of the squares of the “network” have a side measurement of the same squares varying from 1 to 5 mm, depending on the rib-stop value to be obtained from the fabric.

Should the two “networks” by chance coincide, it is possible to increase the thickness of the thread, by coupling conductive textile fibers with the base para-aramidic and/or novoloid yarn.

Also in this case, the basis weights of the fabric are not binding, but can be selected in relation to the specific demands of the individual used and fields of application; finally, the fabric can be produced with the weight considered adequate with respect to the specific use for which it is destined.

The specific characteristics of conductive yarns (high conductivity of electric charges and thermo-energy) coupled with the very high performance fire-resistant properties of novoloid fibers (inert material) and the high mechanical resistance and impact strength of fibers of para-aramidic yarn, give the fabric a high resistance to fire, heat and chemical substances, a reduced emission of fumes and the zero emission of toxic fumes in the case of combustion, a high mechanical resistance and bacterio-static, antistatic and dissipative properties of the electrostatic and tribo-electric charges.

When suitably treated and in addition to all the characteristics described above, the fabric in question can have repellence properties against all chemical liquids and also stain-resistance.

The characteristics of the fabric with high fire-resistance properties, object of the present invention, are evident from the description as also its advantages.

In particular, these consist of:

softness of the fabric which does not burn or carbonize if attacked by flames, until its complete destruction;

reduced emission of fumes in the case of combustion;

absence of toxic fumes in the case of combustion;

high mechanical tear resistance and tensile strength;

very slow wear;

no damage on the part of chemical substances, such as grease, oils, acids, chlorine, etc.;

adequate comfort, thanks to transpiring properties and lightness;

repellence against all chemical liquids;

stain-resistance;

antistatic and dissipative properties of the electrostatic and tribo-electric charges;

anti-microbial, anti-bacterial and bacteriostatic properties (using as conductive yarn a polyamide PA or polyester PES fiber, with a copper sulfide surface);

conductive and shielding properties of the non-ionizing waves generated by electromagnetic fields or radio frequency;

maintenance with time of the specific characteristics described, also in the presence of continuous and different washings of the fabric.

Finally, numerous other variants can obviously be applied to the fireproof fabric in question, all included within the novelty principles inherent to the invention. It is also evident that in the practical embodiment of the invention, the materials, forms and dimensions of the details illustrated can vary according to the demands and can be substituted with other technically equivalent alternatives.

1. A fabric with high fire-resistant properties, comprising different types of yarns joined to each other by means of pre-established techniques in suitable combinations and layers for the uses and fields of applications envisaged, characterized in that said types of yarns comprise at least a first meta-aramidic or para-aramidic fiber and other materials having high fire-resistant properties, which include novoloid and/or at least one fiber based on pre-oxidized carbon.

2. The fabric with high fire-resistant properties according to claim 1, characterized in that said fabric can be of the multilayer composite knitted fabric or shuttle fabric type.

3. The fabric with high fire-resistant properties according to claim 1, characterized in that at least a third natural fiber, made of cotton, wool or viscose, having particular comfort and wearability, is combined with said meta-aramidic or para-aramidic fibers and with said fibers based on pre-oxidized carbon and/or with novoloid fibers.

4. The fabric with high fire-resistant properties according to claim 1, characterized in that at least one textile fiber having conductivity properties is combined with said meta-aramidic or para-aramidic fibers and with said fibers based on pre-oxidized carbon and/or with novoloid, in order to obtain shielding properties of the non-ionizing waves generated by electromagnetic fields and/or antistatic and dissipative properties in general.

5. The fabric with high fire-resistant properties according to claim 1, characterized in that said pre-oxidized carbon fiber has, as precursor, polyacrylonitrile, having elastic properties and a high heat resistance, whereas said meta-aramidic fiber consists of para-phenylene-terephthalamide, which has a high flame and heat resistance and a good mechanical resistance.

6. The fabric with high fire-resistant properties according to claim 5, characterized in that said pre-oxidized carbon fiber has a high heat resistance, resistance to corrosion with acid or basic chemical agents within a pH range of 2 to 14, a linear electrical resistance equal to 10¹¹ Ω/cm, antistatic properties and total dissipation of static electricity, and a minimum particle size of the fiber equal to 6.5 μm.

7. The fabric with high fire-resistant properties according to claim 5, characterized in that said para-aramidic fiber has an impact strength of 67 N, an ultimate tensile stress of 135 CN/TEX and a high impact strength, fire-resistance, a high tensile strength and shock resistance, a high dielectric capacity.

8. The fabric with high fire-resistant properties according to claim 2, characterized in that said multilayer composite fabric is of the knitted type and is obtained by combining the fibers by means of the “vanisé” techniques and “Fàcon Metier” method, said fabric also being possibly double-face.

9. The fabric with high fire-resistant properties according to claim 1, characterized in that said para-aramidic fiber is phenylene-terephthalamide and can comprise a mixture of pre-oxidized carbon fibers up to a maximum of 30% of the latter.

10. The fabric with high fire-resistant properties according to claim 5, characterized in that the polyacrylonitrile can be formed by mixing the para-aramidic fiber with the pre-oxidized carbon fiber, up to a maximum of 60% of the former.

11. The fabric with high fire-resistant properties according to claim 1, characterized in that said fabric comprises at least a first yarn consisting of 100% of para-aramidic fiber and at least a second yarn made up of a mixture of 70% of pre-oxidized carbon fibers and 30% of para-aramidic fibers.

12. The fabric with high fire-resistant properties according to claim 1, characterized in that said fabric is produced by means ‘of weaves with a ’ warp and a weft, with the para-aramidic fiber or the pre-oxidized carbon fiber alternating in weft or warp, or having two warps and two or three wefts in all the combination variants of meta-aramidic and based on pre-oxidized carbon fibers.

13. The fabric with high fire-resistant properties according to claim 1, characterized in that the novoloid is coupled with the para-aramidic phenylene-terephthalamide fiber.

14. The fabric with high fire-resistant properties according to claim 13, characterized in that said para-aramidic fiber can contain a mixture of novoloid, up to a maximum of 30% of the latter.

15. The fabric with high fire-resistant properties according to claim 13, characterized in that the novoloid can contain a mixture of para-aramidic fiber, up to a maximum of 60% of the latter.

16. The fabric with high fire-resistant properties according to claim 12, characterized in that at least one yarn of the same kind but with a greater thickness, of meta-aramidic or para-aramidic fibers and/or based on pre-oxidized carbon, forming said fabric, can be inserted either in the weft or warp, in order to obtain a visible relief on the fabric, which has the appearance of a more or less dense “network”.

17. The fabric with high fire-resistant properties according to claim 4, characterized in that said conductive textile fibers are combined with said para-aramidic fibers, such as phenylene-terephthalamide, and with novoloid, said conductive textile fibers comprising stainless steel filaments, polyamide fibers with a carbonized surface, polyamide fibers with a copper sulfide surface, polyester fibers with a copper sulfide surface, pre-oxidized carbon fibers and/or antistatic filaments based on activated carbon.

18. The fabric with high fire-resistant properties according to claim 17, characterized in that said conductive textile fibers are coupled with said para-aramidic fibers and with said pre-oxidized carbon fibers, by means of spinning and/or weaving techniques.

19. The fabric with high fire-resistant properties according to claim 4, characterized in that said conductive textile fibers have a percentage weight, in relation to the basis weight of the fabric, varying from 1% to 5%.

20. The fabric with high fire-resistant properties according to claim 4, characterized in that said conductive textile fibers have a percentage weight, in relation to the basis weight of the fabric, varying from 10% to 20%.

21. A fabric with high fire-resistant properties as substantially described and for the purposes specified.
